(19) United States
(12) Patent Application Publication
(10) Pub. No.: US 2026/0098159 A1
(43) Pub. Date: Apr. 9, 2026

(54) ANTIREFLECTION COATINGS, METHODS OF MAKING, AND METHODS OF USE

(71) Applicant: University of Florida Research Foundation, Inc., Gainesville, FL (US)

(72) Inventors: Fan Gao, Gainesville, FL (US); Peng Jiang, Gainesville, FL (US); Jiachen Wu, Gainesville, FL (US)

(21) Appl. No.: 19/347,955

(22) Filed: Oct. 2, 2025

Related U.S. Application Data
(63) Continuation-in-part of application No. PCT/US2024/022984, filed on Apr. 4, 2024.
(60) Provisional application No. 63/457,167, filed on Apr. 5, 2023.
(60) Provisional application No. 63/841,539, filed on Jul. 10, 2025.

(51) Int. Cl. C09D 5/00; C04B 35/10; C04B 41/00; C04B 41/45; C04B 41/50; C09D 1/00

(52) U.S. Cl. CPC C09D 5/006; C04B 35/10; C04B 41/0081; C04B 41/4549; C04B 41/5035; C09D 1/00

(57) ABSTRACT

The present disclosure provides for methods of making a substrate having an antireflective coating, substrates having an antireflective coating, and the like. The present disclosure includes methods of increasing durability of the antireflective coating by heat-annealing a coated substrate such that nanoparticles in the coating reach a glass-transition temperature as well as substrates having an antireflective coating made using these methods.

### CROSS-REFERENCE TO RELATED APPLICATIONS

This application claims the benefit of PCT/US2024/022984 having a filing date of Apr. 4, 2024, where the PCT claims priority to U.S. Provisional Application entitled “DURABLE AND ABRASION-RESISTANT ANTIREFLECTION COATINGS, METHODS OF MAKING, AND METHODS OF USE” and having Ser. No. 63/457,167, filed Apr. 5, 2023, which is herein incorporated by reference in their entirety.

This application also claims the benefit of U.S. Provisional Application entitled “ANTIREFLECTION COATINGS, METHODS OF MAKING, AND METHODS OF USE” and having Ser. No. 63/841,539, filed Jul. 10, 2025, which is herein incorporated by reference in their entirety.

### STATEMENT REGARDING FEDERALLY SPONSORED RESEARCH

This invention was made with government support under Grant Number 80NSSC20M0093, awarded by the National Aeronautics & Space Administration. The government has certain rights in the invention.

This invention was supported by the National Aeronautics & Space Administration through the University of Central Florida's NASA Florida Space Grant Consortium.

### BACKGROUND

Typical antireflection coatings with good performance suffer from poor durability and abrasion-resistance. Even monolayers that utilize binders or other interconnections are easily removed from substrates. More durable coatings for optical surfaces that do not reduce performance are required.

### SUMMARY

The present disclosure provides for method of making durable antireflective coating for a substrate such as glass or sapphire, a substrate having a durable antireflective coating, and the like.

The present disclosure provides for a method of making substrate having an antireflective coating, comprising: heat-annealing a coated substrate, wherein the coated substrate has a first side and a second side opposite the first side, wherein prior to heat-annealing the coated substrate includes a first monolayer of self-assembled silica nanoparticles disposed directly onto the first side of a substrate, wherein heat-annealing causes the first monolayer of nanoparticles to reach a glass-transition temperature; and forming a substrate with a first antireflective coating. The present disclosure includes a structure made using the method described above and herein.

The present disclosure provides for a structure comprising: a substrate with a first antireflective coating, wherein the substrate with the first antireflective coating has a specular reflectance of about 1% to 2.5%, and wherein the first antireflective coating is formed from a first self-assembled silica nanoparticle monolayer on a first side of the substate, and wherein the first self-assembled silica nanoparticle monolayer has been heat-treated such that nanoparticles in the first self-assembled silica nanoparticle monolayer have reached at least the glass-transition temperature.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1.1A and 1.1B are camera images of glass substrates with the right half covered with 250 nm close-packed single-layer silica nanoparticles before (FIG. 1.1A) and after (FIG. 1.1B) annealing at 700° C. for 1 minute in accordance with embodiments of the present disclosure.

FIG. 1.2A shows normal-incidence transmittance spectra achieved from a bare glass microslide before and after annealing. FIG. 1.2B shows normal-incidence transmittance spectra obtained from the same glass microslide covered with close-packed colloidal monolayers of 250 nm silica particles before and after annealing in accordance with embodiments of the present disclosure. FIG. 1.2C presents a comparative analysis of the specular optical reflectance measurements acquired from three distinct specimens.

FIG. 1.3A-1.3E are typical top-view SEM images of the close-packed single-layer 250 nm silica nanoparticles (FIG. 1.3A) Before annealing, (FIG. 1.3B) after annealing, (FIG. 1.3C) after 50 times adhesive tape testing, (FIG. 1.3D) after 100 times adhesive tape testing, (FIG. 1.3E) after 200 times wipe rubbing tests in accordance with embodiments of the present disclosure.

FIG. 2.1A-2.1E are photographs of a bare sapphire substrate (FIG. 2.1A), and sapphire substrates coated with close-packed monolayer silica nanoparticles of varying sizes: 100 nm (FIG. 2.1B), 200 nm (FIG. 2.1C), 300 nm (FIG. 2.1D), and 400 nm (FIG. 2.1E).

FIG. 2.2A-2.2D illustrate a top-view SEM images of the LB-assembled colloidal monolayers of (FIG. 2.2A) 100 nm, (FIG. 2.2B) 200 nm, (FIG. 2.2C) 300 nm, and (FIG. 2.2D) 400 nm silica nanoparticles as shown in FIG. 2.1A-2.1E.

FIG. 2.3A and 2.3B illustrate top-view SEM images of 2-inch sapphire wafers covered with LB-assembled 100 nm silica nanoparticles after annealing (FIG. 2.3A) and after 50-cycle adhesion tape tests (FIG. 2.3B).

FIG. 2.4A-2.4C show that the bare sapphire substrate reflects approximately 13% of the incident light across the visible range.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

The present disclosure provides for method of making a substrate having an antireflective coating, a substrate having an antireflective coating, and the like.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, and the like, which are within the skill of the art.

The following examples are put forth so as to provide those of ordinary skill in the art with a complete disclosure and description of how to perform the methods and use the coatings disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### General Discussion

The present disclosure provides for methods of making a substrate having an antireflective coating, substrates having an antireflective coating, and the like. The present disclosure includes methods of increasing durability of the antireflective coating by heat-annealing a coated substrate (e.g., a glass substrate coated with a layer of self-assembled silica nanoparticles) such that nanoparticles in the coating reach a glass-transition temperature.

Advantageously, the method is a simple and inexpensive technology for manufacturing single-sided or double-sided, single-layer, nanoparticle-based antireflection coatings formed using the Langmuir-Blodgett technology. The present disclosure enables high-performance antireflection coatings on substrates, such as glass or sapphire substrates, with significantly improved durability and abrasion resistance than the coatings produced by traditional bottom-up technologies while also having improved transmissive and reflectance properties (e.g., normal-incidence optical transmission of about 96% to 100%).

Embodiments of the present disclosure include substrates having an antireflective coating (e.g., on one or both sides of the substrate). A coated substrate (e.g., substrate having a self-assembled silica nanoparticle monolayer disposed on a first side and/or an opposing second side) can be annealed (e.g., subjected to heat treatment) such that nanoparticles in the self-assembled silica nanoparticle monolayer reach at least the glass transition temperature. Advantageously, flash-annealing causes the silica nanoparticles to melt and shrink slightly, creating a bond both between adjacent nanoparticles and between the nanoparticles and the substrate. This bond increases the durability of the coating without affecting the reflectance and transmittance performance. The substrate having an antireflective coating has improved reflectance and transmittance performance relative to the substrate without the antireflective layer and coated substrate (without annealing). Thus, the substrate having an antireflective coating and the method of making the substrate having an antireflective coating are advantageous relative to known substrates and methods of making substrates.

In an aspect, the present disclosure provides for a substrate with a first antireflective coating. In an aspect, the substrate can include a first antireflective coating and a second antireflective coating. The substrate with the first antireflective coating can have a normal-incidence optical transmission of about 96% to 100%, about 96% to 99%, about 96% to 98%, about 96% to 100%, about 97% to 99%, about 97% to 98%, about 97.5% to 99%, about 97.5% to 98.5%, about 97.5% to 100% and/or a specular reflectance of about 1% to 4%, about 1% to 3%, about 1% to 2.5%, about 1.5% to 2.5%, about 2% to 4%, about 2% to 3%, or about 2% to 2.5%. In an aspect, the first antireflective coating and/or the second antireflective coating can be formed by annealing (e.g., heat treating) a first self-assembled silica nanoparticle monolayer on a first side of the substate and/or a second self-assembled silica nanoparticle monolayer on a second side of the substate, where the first and/or second self-assembled silica nanoparticle monolayer reach at least the glass-transition temperature (e.g., about 650° C. to 750° C.) so that the silica nanoparticles melt and shrink slightly and create a bond both between/among the nanoparticles and between the nanoparticles and the substrate.

In an aspect, the silica nanoparticles of the first self-assembled silica nanoparticle monolayer and the second self-assembled silica nanoparticle monolayer can have a diameter (e.g., longest dimension) of about 50 to 400 nm, about 100 to 400 nm, about 200 to 350 nm, about 200 to 300 nm, about 250 nm, about 100 nm, about 50 to 150 nm, about 50 to 200 nm, or about 75 nm to 125 nm. In an embodiment, silica nanoparticles are silicon dioxide (SiO₂). In an aspect, the silica nanoparticles are spherical or substantially spherical.

In an aspect, the substrate can be flat or substantially flat (e.g., a sheet of glass such as a glass slide or larger (e.g., centimeter to meter range in length and/or width)) or the substrate can include flat, concave, and convex contours such as in glass wear such as a Buchner flask, a burette, a cold finger, a condenser, a cuvette, an Erlenmeyer flask, an Erlenmeyer bulb, a Florence flask, a Freidrichs condenser, a funnel, a pipette, a retort, a round bottom flask, a Schlenk flask, a separatory funnel, a Soxhlet extractor, a Thiele tube, a volumetric flask, a distillation glassware, a vial, a graduated cylinder, a test tube, a bottle, a jar, a spot plate, an evaporation dish, a boiling flask, a suction flask, a crystallization dish, a long condenser, a vacuum adapter, a distillation adapter, and a dropper. In aspect, the substrate can have a first side and an opposing second side. The first side and the second side include the portions of the substrate that are typically larger relative to the edges of the substrate. The edges of the substrate can also include an antireflective layer in addition to those on the first side and/or the second side of the substrate. The substrate can be made of a material such as glass, sapphire, silicon wafers, and polymer-based substrates. The substrate can have a thickness on the millimeter scale (e.g., 0.1 to 100 mm or more) to thicker substrates on the centimeter scale (e.g. 0.5 to 5 cm), where different portions of the substrate can have different thicknesses (the thickness does not refer to the overall size of the substrate, for example a separatory funnel has substrates as wall of the container, so the thickness refers to the wall or a glass slide has a thickness).

In addition, the present disclosure provides for method of making a substrate having an antireflective coating. The method includes heat-annealing a coated substrate. The substrate has a first side and a second side opposite the first side. Prior to heat-annealing, the coated substrate includes a first monolayer of self-assembled silica nanoparticles disposed directly onto the first side of the substrate. The heat-annealing causes the first monolayer of nanoparticles to reach a glass-transition temperature, which causes the silica nanoparticles to melt some and slightly deform to form bonds between/among other silica nanoparticles and with the surface of the substrate. In an aspect, the heat-annealing includes exposing the coated substrate to a temperature of about 700° C. to 750° C. or about 700° C. to 730° C. for a time frame of about 30 second to 5 minutes, about 30 second to 3 minutes, about 30 second to 2 minutes, about 30 second to 90 seconds or about 1 minute. The heat-annealing of the coated substrate transforms the coated substrate to a substrate with a first antireflective coating (e.g., a first antireflective coating on the first side of the substrate and/or a second antireflective coating on the second side of the substrate). The method can also include cooling the coated substrate to form the substrate with the first antireflective coating.

In an aspect, at a wavelength of about 500 nm to 800 nm, the coated substrate has a normal-incidence optical transmission of about 85% to 89% before the heat annealing, and the substrate with the first antireflective coating, the second antireflective coating, or both has a normal-incidence optical transmission of about 96% to 100%, about 96% to 99%, about 96% to 98%, about 96% to 100%, about 97% to 99%, about 97% to 98%, about 97.5% to 99%, about 97.5% to 98.5%, about 97.5% to 100% or a specular reflectance of about 1% to 4%, about 1% to 3%, about 1% to 2.5%, about 1.5% to 2.5%, about 2% to 4%, about 2% to 3%, or about 2% to 2.5%.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

Glass substrates with a typical refractive index of ˜1.5 show a total reflection loss of about 8%¹. In order to reduce optical losses, eliminate “ghost” images and image distortion, and increase energy conversion efficiency when glasses are used as vital components of optical devices such as lenses, displays, and photovoltaic panels (PV), a variety of surface coating and treatment procedures have been applied to achieve antireflection (AR) coatings².

Unlike conventional quarter-wavelength antireflection coatings that require high vacuum deposition conditions and expensive equipment investment, nanoparticle self-assembly provides a simple, scalable, and inexpensive fabrication method to reduce optical reflection over a broad range of wavelengths and angles of incidence. Some nanoparticle self-assembly-based antireflection coating technologies have been explored, such as nanoporous coatings driven by phase separation and selective removal of spin-coated polymer blends, layer-by-layer deposition of nanoparticles and polyelectrolytes assembly on nonplanar substrates, and single-step monolayer nanoparticle self-assembly by Langmuir-Blodgett technology³⁻⁶. Unfortunately, in these technologies there is a trade-off between good antireflection performance and their mechanical properties, such as durability, abrasion and scratch-resistance, which limit their final commercial applications¹.

Described herein is a simple and inexpensive method for increasing the durability and scratch-resistance of a single sided or a double-sided, single-layer, nanoparticle-based antireflection coating formed by the Langmuir-Blodgett technology. Embodiments of the coating can be used in such as solar cells, thermophotovoltaic cells, organic light emitting diodes (OLEDs), lenses for eyewear and laboratory equipment, and semiconductor light emitting diodes².

Monodispersed silica nanoparticles with a diameter of 250 nm were purchased from Particle Solution, LLC. These silica nanoparticles were repeatedly centrifuged and redispersed in pure ethanol to ensure that the particles were well purified. The purified silica nanoparticles were redispersed into ethylene glycol to make a suspension with 1.0 vol%. This suspension was finally used as in the colloidal self-assembly process. The Langmuir-Blodgett and annealing process can also be used with other sizes of particles in suspensions, as can be envisioned by one of ordinary skill in the art.

In a typical Langmuir-Blodgett process, a glass substrate was pre-immersed in water contained in a large glass tank. The silica/ethylene glycol suspension was then slowly dripped onto the water surface. Due to the high surface tension of water, the capillary force assembled the particles floating on the surface into close-packed single-layer colloidal crystals at the water/air interface, which lead to a shining iridescent color by light diffraction. The dripping was stopped until the nanoparticles uniformly covered the entire water surface. The glass substrate was then slowly raised up from the interface at a rate of 20 mm/min, while the close-packed single-layer of 250 nm silica nanoparticles were transferred from the water/air interface to both sides of the hydrophilic surfaces of the glass substrates. The transference is driven by the balance of interfacial and adhesive forces between the silica particles and the glass substrate. When the glass is lowered into water, the monolayer silica particles come into contact with the surface of the glass substrate. At this point, intermolecular attractive forces between the silica particles and the glass substrate surface can cause the monolayer to adhere to the glass substrates.

As can be envisioned by one of ordinary skill in the art, although 250 nm particles are described, other diameters of nanoparticles (e.g., about 100 nm to 400 nm) can be used. In an aspect, the particles have about the same or the same diameter, e.g., about 100 nm, about 200 nm, about 250 nm, about 300 nm, about 350 nm, or about 400 nm. Other substrates can be used, including such as sapphire, silicon wafers, and polymer-based substrates where the annealing conditions are related to the glass transition temperature of the substrate. The thickness of the substrate does not affect the heating time and temperature.

The coated glass substrates were then annealed at about 700° C. for about 1 min using a thermal processing apparatus (RTA, Steag 100CS RTP) under a nitrogen atmosphere top form a substrate with an antireflective layer on the front side and/or back side of the substrate. While other temperatures and annealing times may be used, this combination achieves both performance and low energy consumption.

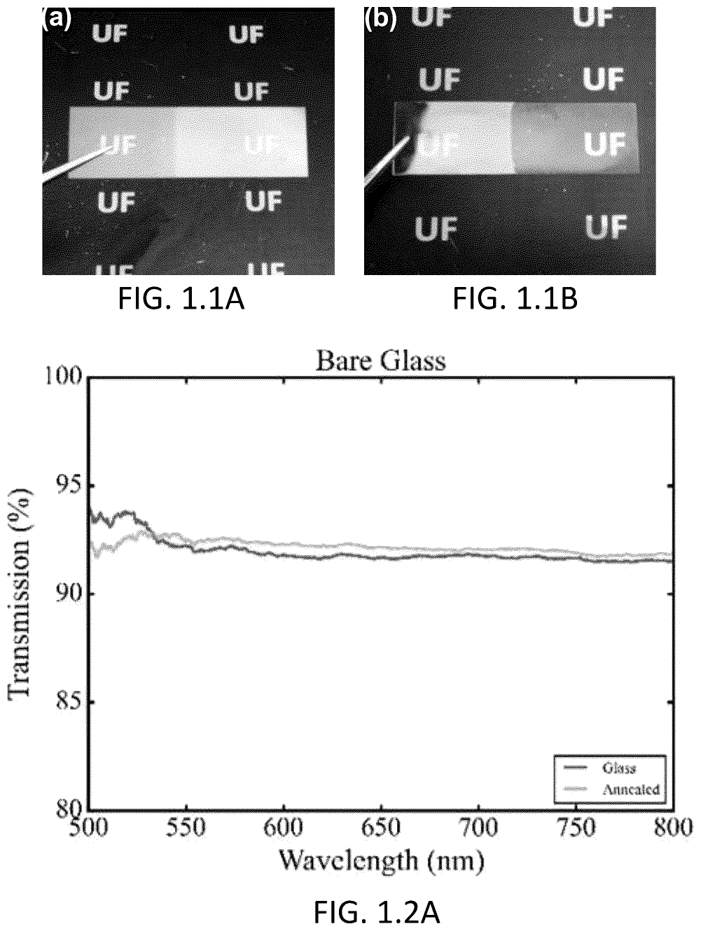

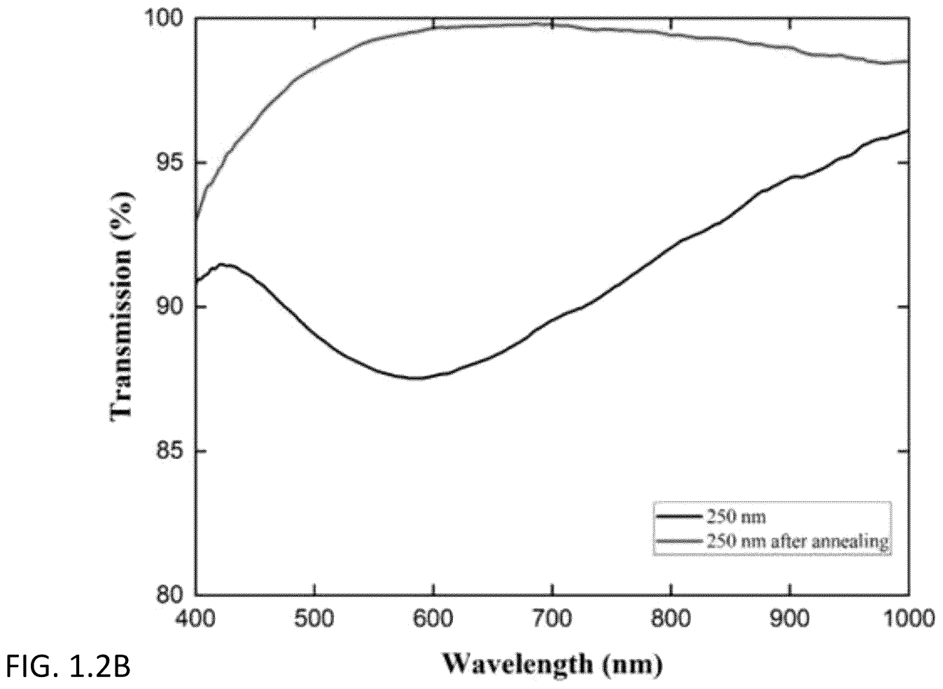

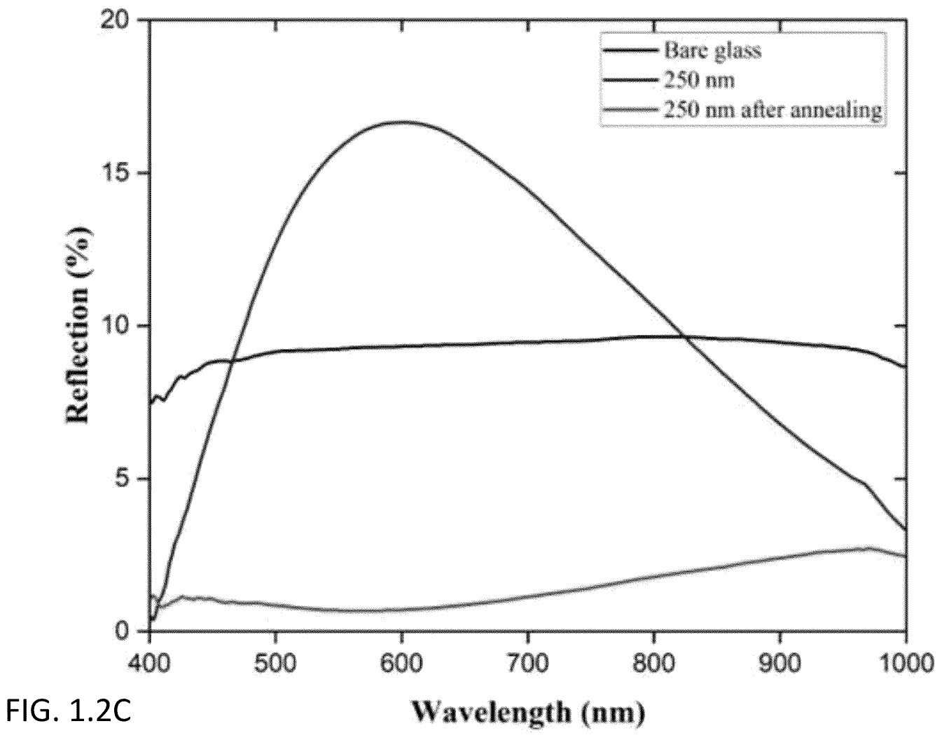

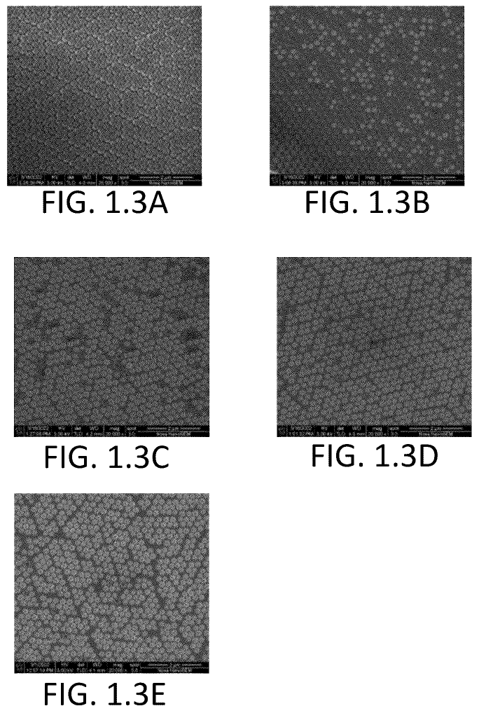

FIG. 1.1A shows a photograph of a glass substrate before annealing with the right half covered by the close-packed single-layer of 250 nm silica nanoparticles. The portion coated with the silica nanoparticles exhibits decreased light transmission compared to the left half of the bare glass substrate. This reduced light transmission through the self-assembled nanoparticles is caused by light diffraction loss from the close-packed nanoparticles with large diameters. In contrast, in FIG. 1.1B, after annealing at 700° C. for 1 minute, the right half of the glass substrate covered with the annealed single-layer silica nanoparticles clearly shows increased light transmission compared to the left half of the bare glass side.

Advantageously, the annealing does not have to be performed within a specific time frame after the coating.

FIG. 1.2B shows the specular optical transmittance measurements of the self-assembled single-layer of 250 nm silica nanoparticles coatings on the glass substrate before and after annealing using an HR4000+NIR512 Vis-NIR spectrometer (Ocean Optics). The transmittance of the annealed antireflection coating averaged about 98% in the broadband range of visible light, which is much higher than the transmittance before annealing that we previously demonstrated through photographs. The transmittance before annealing shown in FIG. 1.2B has mid-to high-80% values. By comparing the transmittance measurement with that of the bare glass substrate in FIG. 1.2A showing a consistent transmittance of about 93%, the transmittance of the 250 nm silica particles is significantly improved after annealing.

As shown in FIG. 1.2A, annealing of bare glass has negligible impact on the transmission percentage. However, in the coated examples (FIG. 1.2B), it is observed that un-annealed samples exhibit a wide range of transmittance values, spanning from a low of 87% to a high of 96%. Notably, the annealing treatment enhances these values by a minimum of 10% within the wavelength range of 500-700 nm. This enhancement culminates in a peak at approximately 600 nm in the light wavelength spectrum.

FIG. 1.2C presents a comparative analysis of the specular optical reflectance measurements acquired from three distinct specimens, namely: (1) a bare glass control sample, (2) a glass microslide coated with Langmuir-Blodgett (LB) assembled colloidal monolayers containing 250 nm silica microspheres, and (3) a same 250 nm silica microsphere-coated glass microslide subjected to annealing. The uncoated glass sample exhibits a double-sided reflectance of approximately 8.5%. Remarkably, the annealed samples display a markedly reduced reflectance, reaching as low as 1% at 550 nm, which is significantly lower in comparison to both the flat control sample and the non-annealed samples. This observation corroborates the superior anti-reflective performance of the annealed samples.

FIG. 1.3A-1.3E are top-view scanning electron microscope (SEM) images of the self-assembled single-layer, close-packed 250 nm silica particles on the glass substrates. From FIG. 1.3A, the continuous hexagonal order of the 250 nm silica particles can be clearly seen with no obvious defects before annealing. FIG. 1.3B-1.3E show SEM images of self-assembled, single-layer, close-packed 250 nm silica particles after annealing, from which it can be seen that the particles shrank slightly after heating, resulting in larger single crystalline domain sizes than before annealing. In contrast to FIG. 1.3B, FIG. 1.3C-1.3E display the SEM images of annealed 250 nm silica particles after 50-and 100-times adhesive tape testing, and 200 times wipe rubbing, respectively. The removal of the annealed silica nanoparticles is minimal after these harsh mechanical scratching and abrasion operations.

In addition, optical transmittance measurements (not shown here) confirm that the annealed nanoparticle antireflection coatings show no obvious difference before and after these mechanical operations. These promising results suggest that the thermal annealing of silica nanoparticle coatings on glass substrates can solve the durability problems encountered by the antireflective coatings prepared by the simple Langmuir-Blodgett technique.

While other methods of annealing, such as chemical annealing and light annealing could potentially be used, this method is currently one of the simplest and cheapest methods that can be applied to industrial mass production.

### REFERENCES

1. Nielsen, K. H., et al., Large area, low cost anti-reflective coating for solar glasses. Solar Energy Materials and Solar Cells, 2014. 128: p. 283-288.
2. Joshi, D. N., et al., Super-hydrophilic broadband anti-reflective coating with high weather stability for solar and optical applications. Solar Energy Materials and Solar Cells, 2019. 200: p. 110023.
3. Askar, K., Et Al., Self-assembled Nanoparticle Antiglare Coatings. Optics Letters, 2012. 37(21): p. 4380-4382.
4. Askar, K., et al., Self-assembled nanoparticle antireflection coatings on geometrically complex optical surfaces. Optics Letters, 2018. 43(21): p. 5238-5241.
5. Askar, K., et al., Rapid electrostatics-assisted layer-by-layer assembly of near-infrared-active colloidal photonic crystals. Journal of Colloid and Interface Science, 2016. 482: p. 89-94.
6. Askar, K., et al., Self-assembled self-cleaning broadband anti-reflection coatings. Colloids and Surfaces A: Physicochemical and Engineering Aspects, 2013. 439: p. 84-100.

### Example 2

Sapphire, known for its exceptional durability, broad spectral transparency, and resistance to thermal and chemical stress, experiences significant reflection losses due to its high refractive index. These reflection losses limit the optical performance of sapphire components, which are used in applications ranging from aerospace to consumer electronics. Most current AR coating technologies for sapphire are expensive and involve complex processes. Here, we investigate the use of a Langmuir-Blodgett (LB)-based methodology as a novel, scalable approach to produce antireflection (AR) coatings on sapphire substrates. We also explore a simple hardening treatment to enhance the coating's mechanical durability, addressing the needs for AR coatings that can withstand harsh environmental conditions. By extending the colloidal self-assembly technique to sapphire substrates, we demonstrate the adaptability and potential of this method as a scalable and cost-effective solution for a wide range of optical applications. The approach overcomes the limitations of traditional AR coating technologies, offering practical, durable, and high-performance alternatives for diverse uses in advanced optical systems.

To achieve effective colloidal self-assembly-based AR coatings on sapphire substrates, several challenges specific to sapphire's unique properties must be addressed.

Sapphire is known for its high refractive index and significant hardness, which make it a favorable material in demanding optical applications but pose challenges for achieving uniform, adherent AR coatings. Traditional quarter-wavelength AR coatings, though effective on glass, are less adaptable to sapphire due to these limiting material properties, especially in terms of achieving an appropriate refractive index gradient and maintaining mechanical stability.

For colloidal self-assembly, strategy such as Langmuir-Blodgett coating is advantageous due to its scalability, simplicity, and ability to form well-ordered monolayers of silica nanoparticles. This technique provides a controlled refractive index gradient that reduces light reflections over a broad spectrum.

Monodisperse spherical silica nanoparticles were synthesized using a modified Stöber method, provided by Particle Solution, LLC. These nanoparticles were subjected to multiple rounds of centrifugation and redispersed in ethanol six times using an ultrasonicator. This step was vital for removing ammonia introduced during the synthesis process and for achieving high particle purity. Subsequently, the purified silica nanoparticles were redispersed in ethylene glycol (EG) to create a 20.0 vol % colloidal suspension. This suspension was then employed in the Langmuir-Blodgett colloidal self-assembly process.

In the Langmuir-Blodgett technique, the sapphire substrates used were meticulously cleaned with acetone, ethanol, and deionized water before being air-dried. These substrates were first pre-immersed in a glass bath filled with deionized water, ensuring the bath was larger than the coating area. The silica/EG suspension was then gradually dripped into the water. Owing to the high surface tension of water, capillary forces push the particles floating on the water surface into a densely packed monolayer colloidal crystal at the water/air interface, displaying a sparkling color through light diffraction. This dripping continued until the nanoparticles uniformly covered the entire water surface. The substrate was then carefully lifted from the interface at a steady rate of 15 mm/min. During this lifting, the closely packed monolayer of silica nanoparticles was transferred from the water/air interface to the hydrophilic surface of the sapphire substrate. To ensure continuous coverage, additional suspension droplets were added during the withdrawal of the substrate as the nanoparticles on the water surface were attached to the substrate surface, compensating for any absence of nanoparticles remaining on the water surface.

To enhance the mechanical durability of the AR coatings on sapphire substrates, a high-temperature annealing process was employed. The annealing process involved heating the coated substrates at 700° C. for 1 minute using a rapid thermal annealing (RTA) apparatus (Steag 100CS RTP) in a controlled nitrogen atmosphere, followed by a natural cooling process to the ambient temperature. This brief but intense heating treatment was designed to sinter the silica nanoparticles, creating partial fusion at contact points between particles and anchoring them firmly to the substrate surface. The surface hardened sapphire substrate is then treated with multiple adhesive tape tests, followed by optical measurements to evaluate their durability.

The adhesion strength of the hardened AR coating was evaluated using a standard tape test with adhesive tapes from Fisher Scientific. During the test, a strip of the tape was securely applied to the surface of the hardened AR coating, ensuring full contact. The tape was subsequently peeled away at a consistent angle and speed, providing a measure of the coating's adhesion to the substrate under tensile stress. Following the tape test, each substrate was rinsed with ethanol at least three times to remove any residual adhesive or particles left by the tape. After rinsing, the substrates were air-dried to prepare them for optical evaluation. The normal-incidence optical transmission spectra were recorded before and after the tape test to determine if any detachment or damage had occurred to the AR coating. By comparing the transmission spectra, the impact of the adhesion test on the AR performance was assessed, allowing for a quantitative evaluation of the coating robustness and long-term stability under mechanical stresses.

All optical measurements, specifically specular reflection and transmission spectra, were conducted using an Ocean Optics spectrometer equipped with a tri-branched fiberglass optical cable. This setup involves a probe that both delivers light from a calibrated halogen light source and collects the light reflected back, which is then analyzed by the spectrometer. The spot size of the light beam is dependent on the distance between the probe and the sample surface, typically maintaining a diameter of about 3 mm where the spectral peak reaches approximately 10,000 intensity units. Measurements were consistently carried out at normal incidence, with the cone angle of light collection maintained at less than 5°.

Prior to optical measurements, a reference spectrum for 100% reflection was recorded. This reference was obtained using an aluminum-sputtered silicon wafer that has a coating thickness of 1000 nm, serving as the total reflection reference. Additionally, a dark reference was acquired by simply switching off the light source, ensuring the system's response to the absence of incident light was accurately captured.

The measurements of the transmission spectra began with performing dark calibration, which accounts for electronic noise, followed by a reference calibration using a blank sample to establish a baseline. Position the substrate vertically between the light source and detector, ensuring proper alignment for accurate measurement.

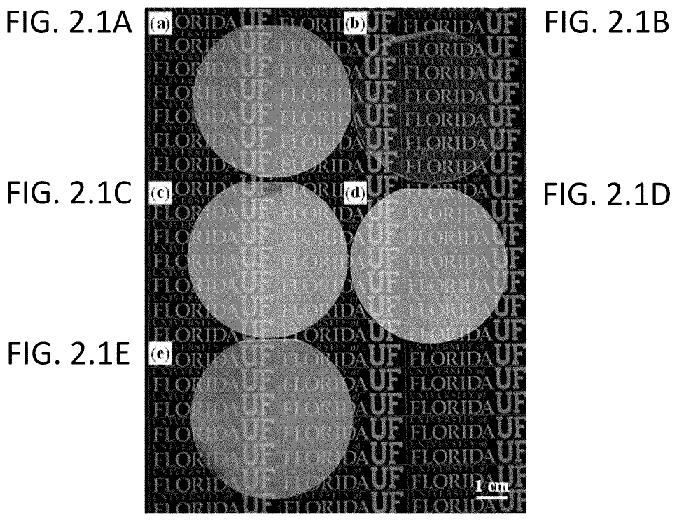

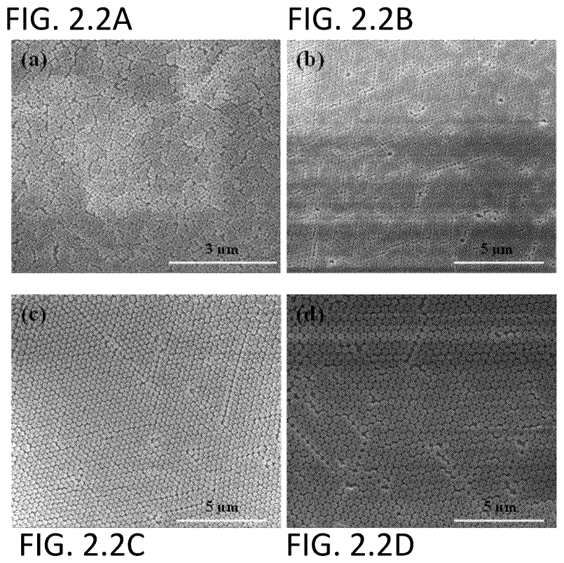

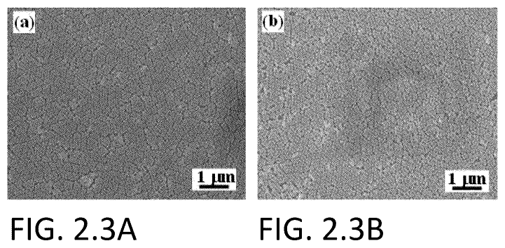

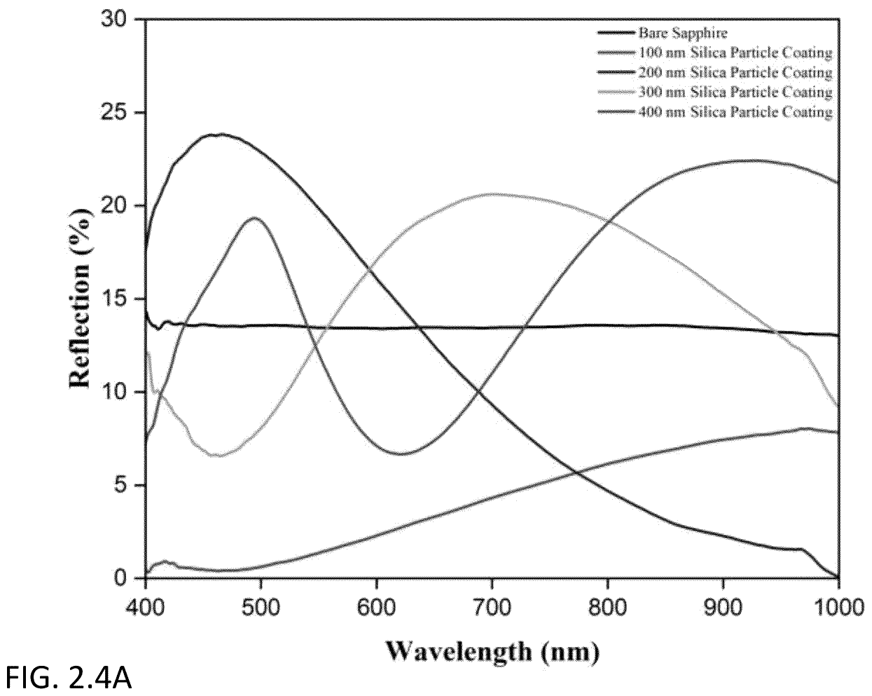

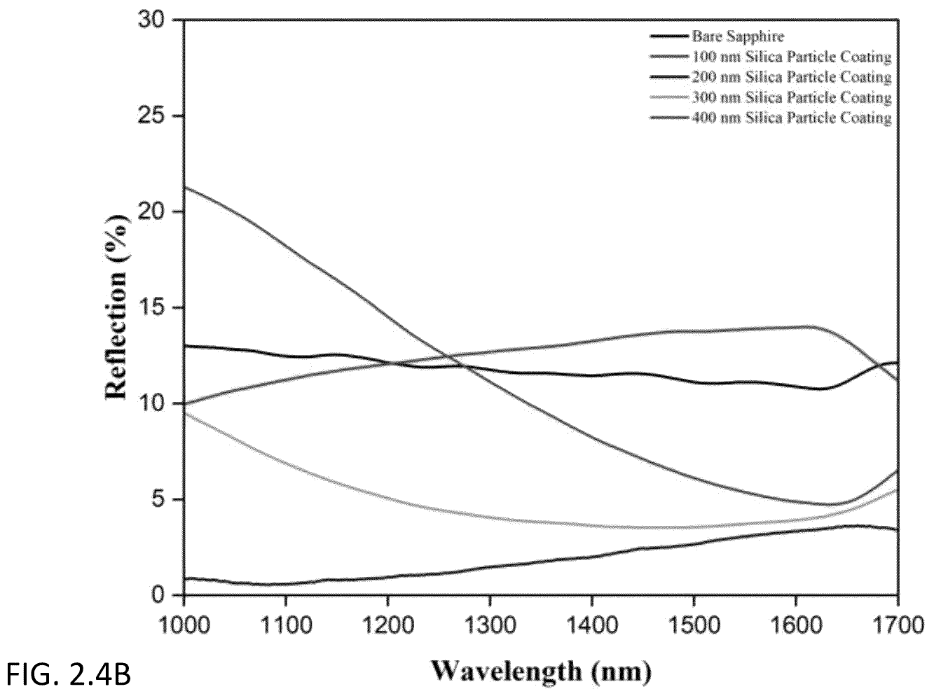

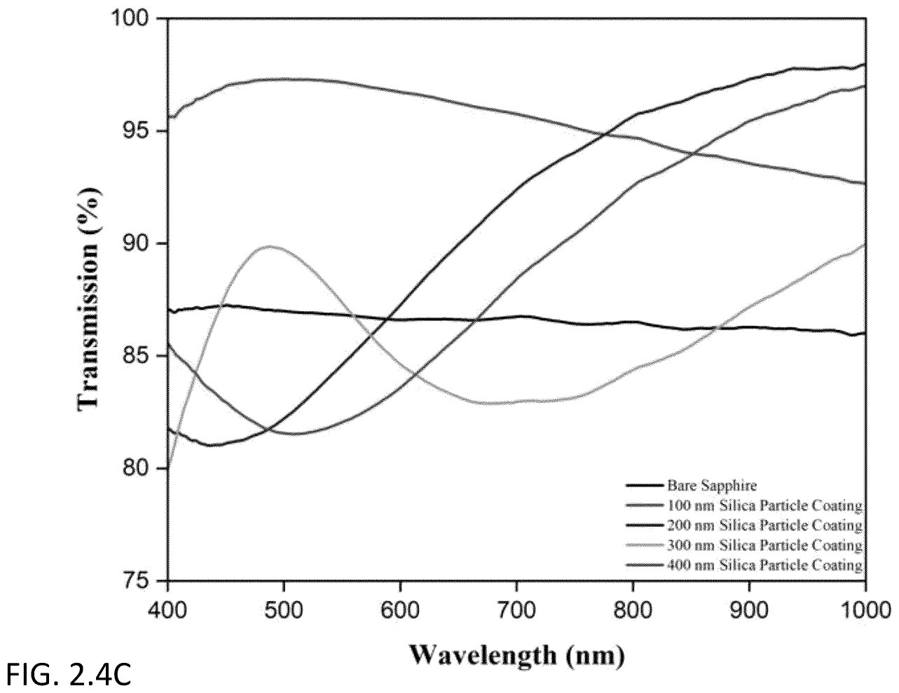

We experimented with LB-based AR coatings on sapphire, detailed in FIG. 2.1A-E, demonstrating the effectiveness of this technique in fabricating AR coatings using silica nanoparticles of various sizes. FIG. 2.1 presents a visual comparison between an uncoated sapphire substrate (FIG. 2.1A) and sapphire substrates coated with antireflective layers consisting of silica nanoparticles of varying sizes ranging from 100 nm to 400 nm (FIG. 2.1B-1E). The section treated with 100 nm silica nanoparticles (FIG. 2.1B) shows a notable reduction in light reflection when compared with the bare sapphire substrate, indicating effective antireflective properties for visible light. In contrast, the substrates coated with larger silica particles—200 nm (FIG. 2.1C), 300 nm (FIG. 2.1D), and 400 nm (FIG. 2.1E) display an increase in visible light reflection compared with the uncoated sapphire substrate, suggesting less effective antireflective performance with increasing nanoparticle size at the visible light range.

Scanning electron microscope (SEM) images in FIG. 2.2A-2.2D display top-view images of self-assembled, monolayer, close-packed silica nanoparticles ranging in diameter from 100 nm to 400 nm (FIG. 2.2A-2.2D), corresponding to the LB-coated sapphire substrates depicted in FIG. 2.1B-2.1E. The images confirm the successful formation of close-packed, hexagonally ordered colloidal monolayers for each nanoparticle size, demonstrating minimal defects and a clear increase in single crystalline domain size from FIG. 2.2A to FIG. 2.2D, as nanoparticle diameter increases from 100 nm to 400 nm. This trend aligns well with the critical role of the capillary forces in assembling nanoparticles in the LB process, where the larger particle size enhances capillary action between neighboring particles, promoting the formation of larger, well-ordered crystalline domains. While larger domains can contribute to structural stability, these larger nanoparticles shift the operating AR wavelengths away from the visible range toward longer wavelengths, as reflected in the subsequent optical measurements.

The durability of these self-assembled nanoparticle AR coatings on sapphire is further validated by FIG. 2.3A-2.3B, which presents top-view SEM images after annealing (FIG. 2.3A) and after 50-cycle adhesion tape test (FIG. 2.3B). The images show no visible defects or nanoparticle detachment, indicating that the sapphire substrates provide a stable base and that the annealed nanoparticle monolayer can withstand mechanical stresses without compromising optical performance. This durability test supports the feasibility of applying LB-coated AR films on sapphire substrates for robust optical applications, particularly in environments requiring high wear resistance.

Optical measurements in FIG. 2.4A-2.4C offer additional insights into the AR performance across visible and near-IR wavelengths. Specular reflection spectra in FIG. 2.4A-4B show that the bare sapphire substrate reflects approximately 13% of the incident light across the visible range. Coating the sapphire substrate with 100 nm silica nanoparticles significantly reduces reflectance, achieving a minimum of approximately 1% reflectance at 450 nm, consistent with the visible AR performance shown in FIG. 2.1B. Larger nanoparticle sizes (200 nm, 300 nm, and 400 nm), however, show increased reflectance in the visible region, indicating reduced AR effectiveness. Interestingly, in the near-IR region, the reflectance drops significantly for these larger particles: 200 nm coating reaches a reflectance of around 1% at 1100 nm, while 300 nm and 400 nm coatings show lower reflectance at approximately 1600 nm. This suggests that the LB technique is well-suited for multi-wavelength applications on sapphire substrates, particularly where both visible and near-IR AR performance are needed.

The transmission spectra in FIG. 2.4C further confirms these trends. The 100 nm nanoparticle-coated sample maintains high transmittance (˜97%) in the visible range, demonstrating effective AR properties with minimal light loss. Conversely, the samples coated with 200 nm to 400 nm nanoparticles exhibit lower transmittance in the visible region, consistent with higher reflectance observed in the corresponding reflection spectra, but they show potential for improved transmittance in near-IR applications.

Sapphire, characterized by its high refractive index and exceptional mechanical properties, requires specialized treatment to achieve effective AR coatings. Here we demonstrated that LB-assembled nanoparticle AR coatings can effectively reduce light reflection from sapphire surfaces, achieving reflectance lower than 3% in the visible range. Although performance on sapphire was not as high as that observed on glass substrates, the scalability and cost-effectiveness of the LB method provide a viable alternative to more expensive and complex AR coating technologies. Furthermore, our annealing treatment effectively improved the mechanical durability of these coatings, ensuring that the AR performance could be maintained even under challenging environmental conditions.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A method of making a substrate having an antireflective coating, comprising:
heat-annealing a coated substrate, wherein the coated substrate has a first side and a second side opposite the first side, wherein prior to heat-annealing the coated substrate includes a first monolayer of self-assembled silica nanoparticles disposed directly onto the first side of a substrate, wherein heat-annealing causes the first monolayer of nanoparticles to reach a glass-transition temperature; and
forming a substrate with a first antireflective coating.

2. The method of claim 1, further comprising: cooling the coated substrate to form the substrate with the first antireflective coating.

3. The method of claim 1, wherein prior to heat-annealing the coated substrate, the coated substrate includes a second monolayer of self-assembled silica nanoparticles disposed directly onto the second side of a substrate, wherein heat-annealing causes the second monolayer of nanoparticles to reach a glass-transition temperature

4. The method of claim 1, further comprising: cooling the coated substrate to form the substrate with the first antireflective coating on the first side of the substrate and a second antireflective coating on the second side of the substrate.

5. The method of claim 1, wherein the heat-annealing comprises exposing the coated substrate to a temperature of about 700° C. to 730° C. for about 30 second to 5 minutes.

6. The method of claim 1, wherein the heat-annealing comprises exposing the coated substrate to a temperature of about 700° C. for about 1 minute.

7. The method of claim 2, where at a wavelength of about 500 nm to 800 nm:
the coated substrate has a normal-incidence optical transmission of about 85% to 89% before the heat annealing, and
the substrate with the first antireflective coating, the second antireflective coating, or both has a normal-incidence optical transmission of about 96% to 100%.

8. The method of claim 1, where at a wavelength of about 500 nm to 800 nm: the substrate with the first antireflective coating, the second antireflective coating, or both has a specular reflectance of about 1% to 2.5%.

9. The method of claim 1, wherein the first self-assembled silica nanoparticle monolayer is comprised of about 100 to 400 nm silica nanoparticles.

10. The method of claim 9, wherein the first self-assembled silica nanoparticle monolayer is comprised of about 250 nm silica nanoparticles.

11. The method of claim 1, wherein the substrate is made of a material selected from: glass, sapphire, a silicon wafer, or a polymer-based substrate.

12. The method of claim 1, wherein the substrate is made of sapphire.

13. A structure made for the method of claim 1.

14. A structure comprising: a substrate with a first antireflective coating, wherein the substrate with the first antireflective coating has a specular reflectance of about 1% to 2.5%, and wherein the first antireflective coating is formed from a first self-assembled silica nanoparticle monolayer on a first side of the substate, and wherein the first self-assembled silica nanoparticle monolayer has been heat-treated such that nanoparticles in the first self-assembled silica nanoparticle monolayer have reached at least the glass-transition temperature.

15. The structure of claim 14, wherein the first self-assembled silica nanoparticle monolayer is comprised of about 100 to 400 nm silica nanoparticles.

16. The structure of claim 15, wherein the first self-assembled silica nanoparticle monolayer is comprised of about 250 nm silica nanoparticles.

17. The structure of claim 14, wherein the substrate has a second side opposite the first side, wherein the second side has a second antireflective coating, and wherein the second antireflective coating is formed from a second self-assembled silica nanoparticle monolayer on a second side of the substate, and wherein the second self-assembled silica nanoparticle monolayer has been heat-treated such that nanoparticles in the second self-assembled silica nanoparticle monolayer have reached at least the glass-transition temperature.

18. The structure of claim 14, wherein the substrate is made of a material selected from:
glass, sapphire, silicon wafers, and polymer-based substrates.

19. The structure of claim 14, wherein the substrate is made of sapphire.

20. The structure of claim 19, wherein the first self-assembled silica nanoparticle monolayer is comprised of about 100 nm silica nanoparticles.
